(19) United States
(12) Patent Application Publication
(10) Pub. No.: US 2020/0283076 A1
(43) Pub. Date: Sep. 10, 2020

(54) An Aerodynamic Device

(71) Applicant: Wirth Research Limited, Bicester Oxfordshire (GB)

(72) Inventor: Nicholas J.P. Wirth, Northamptonshire (GB)

(21) Appl. No.: 16/088,738

(22) PCT Filed: Nov. 30, 2016
(86) PCT No.: PCT/GB2016/053755

§ 371 Date: Sep. 26, 2018

(30) Foreign Application Priority Data
Mar. 31, 2016 (GB) 1605428.0

(51) Int. Cl. B62D 35/00

(52) U.S. Cl. CPC B62D 35/001; B62D 35/005

(57) ABSTRACT

An aerodynamic device for a front surface of a trailer, the device comprising: a duct having an inlet and an outlet; wherein the inlet is configured to be vertically oriented so as to receive air deflected down the front surface of the trailer and the duct is curved along its length to divert the air from vertical towards horizontal.

### TECHNICAL FIELD

The invention relates to an aerodynamic device for a front surface of a trailer.

### BACKGROUND

In recent years the requirement for the reduction of fuel consumption of commercial vehicles has become increasingly important. This is due to a combination of ever increasing fuel prices and a requirement for a reduction in CO2 emissions for environmental purposes. One way to obtain considerable reductions in fuel consumption is by the reduction of the aerodynamic drag of vehicles.

The development of aerodynamic components for both tractors and trailers has, therefore, been a thriving area of research. There have been many drag-reducing devices for trucks developed including fairings, deflectors and vortex generating vanes (for example, see EP2809568).

In order to reduce the number of haulage trucks on the roads, it is desirable to maximize the load capacity of each truck. Accordingly, there has been a drive towards taller trailers, particularly those with double decks. For example, on UK motorways bridges are normally 5.1 m high and so trailers of up to 4.95 m are commonly used. The advent of such trailers creates a mismatch between these taller trailers and existing tractor units which were designed for lower trailers of around 4 m in height. Although tractor units are often provided with roof fairings to deflect air over the top of the trailer, these are unable to be raised sufficiently to accommodate the tallest trailers. As a result, the front surface of the trailer projects above the top of the tractor creating significant drag which in turn reduces fuel efficiency.

It is therefore desirable to address the mismatch between the tractor unit and the trailer in order to reduce drag.

### SUMMARY

In accordance with an aspect of the invention, there is provided an aerodynamic device for a front surface of a trailer, the device comprising: a duct having an inlet and an outlet; wherein the inlet is configured to be vertically oriented so as to receive air deflected down the front surface of the trailer and the duct is curved along its length to divert the air from vertical towards horizontal.

The duct may comprise a first duct and a second duct, wherein the first and second ducts diverge laterally from one another.

The first and second ducts may have a common inlet.

The first and second ducts may be defined by a deflecting wedge disposed within a cavity, the deflecting wedge having diverging surfaces.

The cavity may be defined by a cover fairing which is spaced from a base layer along an upper edge to form the inlet and wherein the deflecting wedge is disposed between the cover fairing and the base layer.

An outlet of each of the first and second ducts may be defined between side edges of the cover fairing and the base layer.

The outlets may be formed by a recess in the base layer.

The aerodynamic device may further comprise a horizontal baffle configured to be positioned forward of and below the inlet of the duct.

The aerodynamic device may further comprise a bulbous protrusion configured to be positioned above the inlet of the duct and being shaped to deflect air away from a central region.

The duct may be configured to divert the air around a side of the trailer.

### BRIEF DESCRIPTION OF THE DRAWINGS

For a better understanding of the invention, and to show more clearly how it may be carried into effect, reference will now be made, by way of example, to the accompanying drawings, in which:—

FIG. 1 is a perspective view of a trailer having an aerodynamic device according to an embodiment of the invention;

FIG. 2 is a side cross-sectional view of the trailer;

FIG. 3 is a side view of the trailer showing the air flow through the aerodynamic device;

FIG. 4 is a side view of a truck comprising the trailer and showing the air flow over the truck; and

FIG. 5 is a perspective view of the truck showing the air flow.

### DETAILED DESCRIPTION

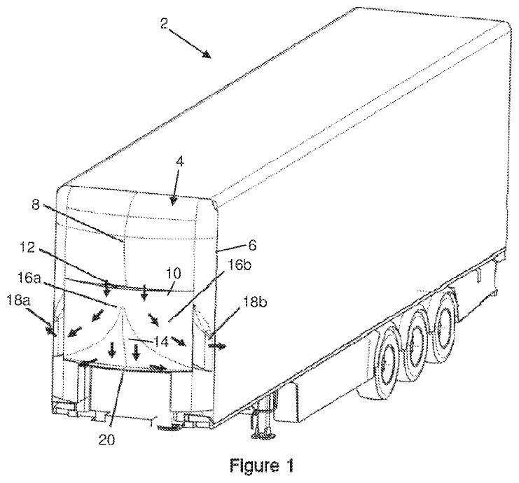

FIG. 1 shows a trailer 2 of a truck which comprises the trailer 2 and a tractor unit (not shown in FIG. 1) which drives the trailer 2. The trailer 2 is a semi-trailer since it does not have a front axle and thus its weight is supported by the tractor unit during use.

As shown, an aerodynamic device 4 according to an embodiment of the invention is provided on a front surface of the trailer 2.

The aerodynamic device 4 comprises a base layer 6 which is affixed to the front surface of the trailer 2. A bulbous protrusion 8 is formed at an upper region of the base layer 6.

The bulbous protrusion 8 defines an outer surface which projects forwards of the front surface of the trailer 2. The outer surface of the bulbous protrusion 8 has a central region which projects forward of the front surface of the trailer 2 by a maximum value and is contoured such that it tapers from the central region in both the vertical and horizontal directions. Specifically, the outer surface of the bulbous protrusion 8 has a positive curvature such that, at the central region, a plane tangential to the outer surface is substantially parallel to the front surface of the trailer 2 and moving away from the central region a plane tangential to the outer surface is rotated towards being perpendicular to the front surface of the trailer 2. The curvature of the outer surface of the bulbous protrusion 8 may increase at the sides and top of the bulbous protrusion 8 so as to form a smooth transition to the top and side surfaces of the trailer 2. In contrast, the curvature of the outer surface may decrease or reverse at the bottom of the bulbous protrusion 8 so as to form a smooth transition to a lower region of the front surface of the trailer 2.

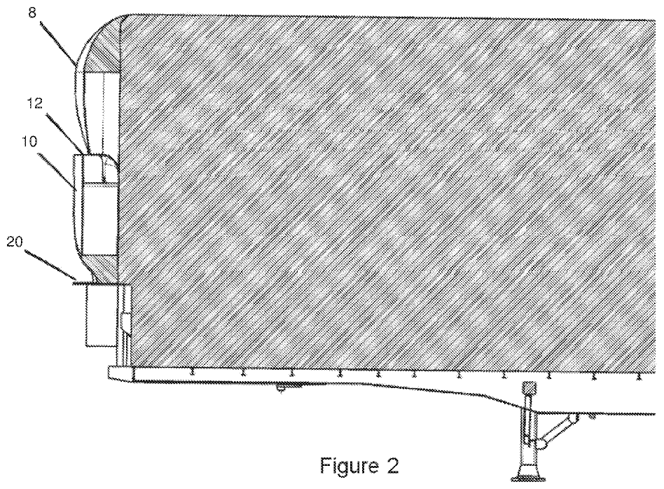

The aerodynamic device 4 further comprises a lower air diverter formed by a fairing or cover 10 (shown as transparent for clarity) which is positioned at a lower region of the base layer 6 below the bulbous protrusion 8. The cover 10 is formed by a rectangular plate which is curved along its width. A lower edge of the cover 10 is connected to the base layer 6. The cover 10 is also connected to the base layer 6 along an upper section of each of its side edges. As shown in FIGS. 1 and 2, an upper edge of the cover 10 is spaced from the base layer 6 to define a vertically-orientated inlet opening 12. As described above, the cover 10 is curved along its width. The inlet opening 12 is therefore widest at its center and tapers towards the sides of the cover 10.

The base layer 6 further comprises a deflecting wedge 14 which is located beneath the cover 10. The deflecting wedge 14 is formed by a pair of curved surfaces which diverge from an upper point toward each side of the base layer 6. The deflecting wedge 14 therefore divides a pocket or envelope formed by the cover 10 into first and second ducts 16a, 16b. As shown, the upper point of the deflecting wedge 14 is positioned below the level of the upper edge of the cover 10 and so the inlet opening 12 forms a common inlet to the first and second ducts 16a, 16b. The first and second ducts 16a, 16b exit out of each side of the cover 10 via a pair of outlet ports 18a, 18b which are formed by recesses in the base layer 6.

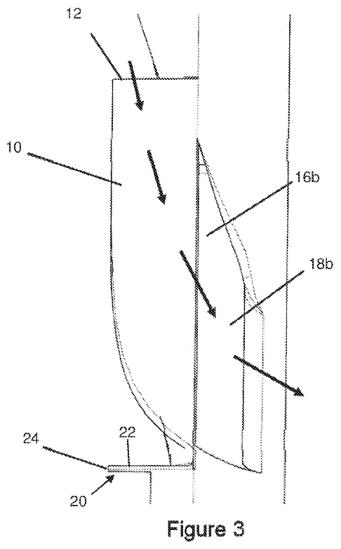

The aerodynamic device 4 further comprises a horizontal baffle 20. The horizontal baffle 20 is formed by a ledge which projects from the lower edge of the cover 10 (or adjacent thereto) and extends across the width of the cover 10. As shown in FIG. 3, the baffle 20 defines an upper deflecting surface 22 and a curved front surface 24.

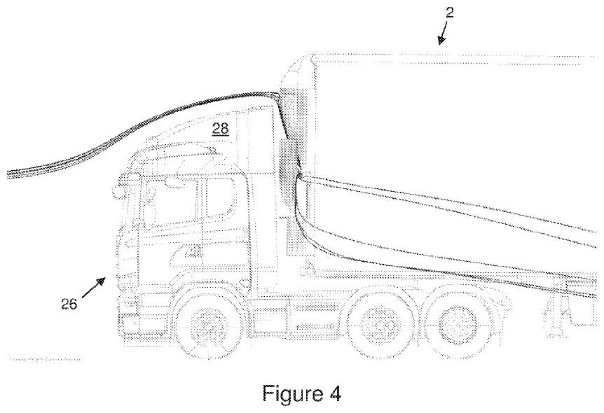

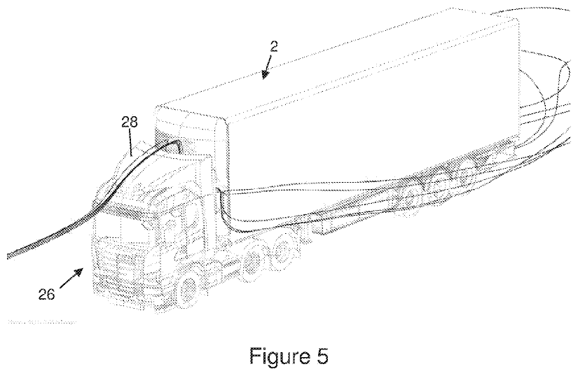

FIGS. 4 and 5 show the trailer 2 with the aerodynamic device 4 attached to a tractor unit 26.

As shown, the tractor unit 26 comprises a roof fairing 28 which, in use, diverts oncoming air upwards over the cab of the tractor unit 26. Owing to the height of the trailer 2, the roof fairing 28 is not able to divert the air over the top of the trailer 2 and so the air would ordinarily hit the front surface of the trailer 2 and be directed downwards into the space between the tractor unit 26 and the trailer 2. This downwash has been found to feed into a wake created by the rotating tires of the tractor unit 26, thereby increasing the aerodynamic drag. However, the use of the aerodynamic device 4 has been shown to reduce the aerodynamic drag, as will be described below.

As shown in FIGS. 4 and 5, the oncoming air deflected over the cab of the tractor unit 26 by the roof fairing 28 contacts the bulbous protrusion 8. The bulbous protrusion 8 deflects the oncoming air. Specifically, air which contacts the bulbous protrusion 8 above the central region is deflected over the top of the trailer 2, air which contacts the bulbous protrusion 8 towards its sides is deflected around the sides of the trailer 2, and air which contacts the bulbous protrusion 8 below the central region is deflected downwards towards the inlet opening 12.

The air which is deflected downwards by the bulbous protrusion 8 enters the inlet opening 12 and is divided between the first and second ducts 16a, 16b by the deflecting wedge 14. The divergent surfaces of the deflecting wedge 14 forces the air laterally towards the sides of the aerodynamic device 4 where it exits the ducts 16a, 16b via the outlet ports 18a, 18b. The downwash from the bulbous protrusion 8 is therefore redirected to provide a lateral component to the air flow such that the air is forced around the sides of the trailer 2, thereby avoiding the wheels of the tractor unit 26.

Air which is deflected downwards by the bulbous protrusion 8, but which fails to enter the inlet opening 12 and instead flows over the front of the cover 10, contacts the baffle 20. The baffle 20 thus inhibits further downwards movement of the air and therefore prevents the air from being fed into the wake created by the rotating tires of the tractor unit 26.

The use of the aerodynamic device 4 has been shown to provide a drag reduction in excess of 10%, thereby improving fuel efficiency by over 5%.

It will be appreciated that the aerodynamic device of the invention may be supplied as a panel to be retrofitted to an existing trailer or may be formed as an integral part of a new trailer.

The upper air deflector formed by the bulbous protrusion 8 may have a different form to that described. For example, the bulbous protrusion 8 may comprise several angled surfaces rather than the curved surface described.

The lower air diverter may have two separate inlet openings, rather than a common inlet opening for the first and second ducts 16a, 16b. For example, the deflecting wedge 14 may extend up to the upper edge of the cover 10 so that the entire pocket or envelope formed by the cover 10 is divided into the first and second ducts 16a, 16b. In fact, the first and second ducts 16a, 16b may be formed by conduits which diverge such that there is no requirement for a separate deflecting wedge 14.

The first and second ducts 16a, 16b may extend down the sides of the trailer 2 such that the outlet ports 18a, 18b are formed on the sides of the trailer 2 or at the rear of the trailer 2. A single duct may also be used to redirect air down one side of the trailer 2. The or each duct may also pass through the interior of the trailer 2. For example, a duct may pass vertically down the front surface of the trailer 2 and then bend so as to extend horizontally along the length of the trailer 2. The duct may pass within the interior of the trailer 2 (e.g. through a hollow bed) or underneath the chassis of the trailer 2 and exit at the rear of the trailer 2 or at a suitable position along the length of the trailer 2. It is therefore not necessary for the air to be redirected around the sides of the trailer 2. The duct does, however, divert air which is flowing vertically downwards towards horizontal (laterally or rearward) so as to avoid the air being fed into the wake of the wheels.

The cover 10 need not form ducts having a closed cross-section. For example, in other embodiments, the first and second ducts 16a, 16b may be open at their sides.

The upper bulbous protrusion and the lower air diverter may be formed as separate components. Moreover, the lower air diverter may be used without the upper bulbous protrusion.

The invention is not limited to the embodiments described herein, and may be modified or adapted without departing from the scope of the present invention.

1. An aerodynamic device for a front surface of a trailer, the device comprising:
a duct having an inlet and an outlet;
wherein the inlet is configured to be vertically oriented so as to receive air deflected down the front surface of the trailer and the duct is curved along its length to divert the air from vertical towards horizontal.

2. An aerodynamic device as claimed in claim 1, wherein the duct comprises a first duct and a second duct, wherein the first and second ducts diverge laterally from one another.

3. An aerodynamic device as claimed in claim 2, wherein the first and second ducts have a common inlet.

4. An aerodynamic device as claimed in claim 2, wherein the first and second ducts are defined by a deflecting wedge disposed within a cavity, and wherein the deflecting wedge having diverging surfaces.

5. An aerodynamic device as claimed in claim 4, wherein the cavity is defined by a cover fairing which is spaced from a base layer along an upper edge to form the inlet and wherein the deflecting wedge is disposed between the cover fairing and the base layer.

6. An aerodynamic device as claimed in claim 5, wherein an outlet of each of the first and second ducts is defined between side edges of the cover fairing and the base layer.

7. An aerodynamic device as claimed in claim 6, wherein the outlets are formed by a recess in the base layer.

8. An aerodynamic device as claimed in claim 1, further comprising a horizontal baffle configured to be positioned forward of and below the inlet of the duct.

9. An aerodynamic device as claimed in claim 1, further comprising a bulbous protrusion configured to be positioned above the inlet of the duct and being shaped to deflect air away from a central region.

10. An aerodynamic device as claimed in claim 1, wherein the or each duct is configured to divert the air around a side of the trailer.

11. A trailer comprising an aerodynamic device as claimed in claim 1.
